(19) United States
(12) Patent Application Publication
(10) Pub. No.: US 2026/0086884 A1
(43) Pub. Date: Mar. 26, 2026

(54) METHOD, DEVICE, AND COMPUTER PROGRAM PRODUCT FOR OFFLOADING COMPRESSION LOAD

(71) Applicant: Dell Products L.P., Round Rock, TX (US)

(72) Inventors: Chenxi Hu, Beijing (CN); Weibing Zhang, Beijing (CN); Zhen Jia, Shanghai (CN); Zhenzhen Lin, Shanghai (CN)

(21) Appl. No.: 18/920,253

(22) Filed: Oct. 18, 2024

(30) Foreign Application Priority Data
Sep. 20, 2024 (CN) 202411322621.1

(51) Int. Cl. G06F 9/50

(52) U.S. Cl. CPC G06F 9/5088; G06F 2209/508; G06F 2209/509

(57) ABSTRACT

A method in an illustrative embodiment includes determining a compression ratio of a service processor (SP) in a storage system based on raw data and compressed data. The method further includes determining whether the compression ratio of the SP is greater than a predetermined threshold. The method further includes determining, in response to the compression ratio of the SP being greater than the predetermined threshold, a target virtual data migrator (VDM) associated with a compression task from a plurality of VDMs in the SP. The method further includes offloading the target VDM to a data processing unit (DPU) connected to the SP. In this way, the DPU can be used to expand the resources of the SP, process compression tasks, reduce the load on a CPU in the SP, and improve the compression efficiency and system performance.

### RELATED APPLICATION

The present application claims priority to Chinese Patent Application No. 202411322621.1, filed Sep. 20, 2024, and entitled “Method, Device, and Computer Program Product for Offloading Compression Load,” which is incorporated by reference herein in its entirety.

### FIELD

The present disclosure relates to the field of load management, and more specifically, to a method, a device, and a computer program product for offloading a compression load.

### BACKGROUND

With the in-depth development of network applications, the amount of data transmitted between clients and servers has increased dramatically. Faced with the current situation of limited bandwidth resources and the requirement for increasing transmission efficiency, relevant technologies use the Server Message Block (SMB) protocol as a solution. The continuous optimization of the SMB protocol, especially the enhancement in data compression function, provides strong support for network transmission. The protocol allows users and servers to configure flexibly, aiming to improve the overall network performance by reducing the amount of transmitted data and alleviating the bandwidth pressure.

The SMB compression technology provides users and administrators with highly flexible configuration options. The users can decide whether to enable a compression function based on specific needs, such as file type and network condition. The administrators can pre-define compression strategies to more finely control the data transmission process. When a data transmission request occurs, a server will automatically compress data according to a preset strategy or user selection, and transmit it efficiently through the SMB protocol.

### SUMMARY

Embodiments of the present disclosure include a method, a device, and a computer program product for offloading a compression load.

In a first aspect of embodiments of the present disclosure, a method for offloading a compression load is provided. The method includes determining a compression ratio of a service processor (SP) in a storage system based on raw data and compressed data. The method further includes determining whether the compression ratio of the SP is greater than a predetermined threshold. The method further includes determining, in response to the compression ratio of the SP being greater than the predetermined threshold, a target virtual data migrator (VDM) associated with a compression task from a plurality of VDMs in the SP. The method further includes offloading the target VDM to a data processing unit (DPU) connected to the SP.

In a second aspect of embodiments of the present disclosure, an electronic device is provided. The electronic device includes at least one processor, and memory coupled to the at least one processor and having instructions stored therein, wherein the instructions, when executed by the at least one processor, cause the electronic device to perform actions. The actions comprise determining a compression ratio of an SP in a storage system based on raw data and compressed data, determining whether the compression ratio of the SP is greater than a predetermined threshold, determining, in response to the compression ratio of the SP being greater than the predetermined threshold, a target VDM associated with a compression task from a plurality of VDMs in the SP, and offloading the target VDM to a DPU connected to the SP.

In a third aspect of embodiments of the present disclosure, a computer program product is provided. The computer program product is tangibly stored on a non-transitory computer-readable medium and comprises machine-executable instructions which, when executed by a machine, cause the machine to perform actions. The actions comprise determining a compression ratio of an SP in a storage system based on raw data and compressed data, determining whether the compression ratio of the SP is greater than a predetermined threshold, determining, in response to the compression ratio of the SP being greater than the predetermined threshold, a target VDM associated with a compression task from a plurality of VDMs in the SP, and offloading the target VDM to a DPU connected to the SP.

It should be understood that the content described in this Summary is neither intended to limit key or essential features of embodiments of the present disclosure, nor intended to limit the scope of the present disclosure. Other features of the present disclosure will become readily understood from additional description provided herein.

### BRIEF DESCRIPTION OF THE DRAWINGS

The above-mentioned and other features, advantages, and aspects of embodiments of the present disclosure will become more apparent with reference to the accompanying drawings and the following Detailed Description. In the accompanying drawings, identical or similar reference numerals represent identical or similar elements, in which:

FIG. 1 shows a schematic diagram of an example environment in which multiple embodiments of the present disclosure may be implemented;

FIG. 2 shows a flow chart of a method for offloading a compression load according to some embodiments of the present disclosure;

FIG. 3A shows a schematic diagram of the connection between a central processing unit (CPU) and a DPU according to some embodiments of the present disclosure;

FIG. 3B shows a schematic diagram of an architecture of a DPU according to some embodiments of the present disclosure;

FIG. 3C shows a schematic diagram of a process of performing data transmission between a client and a server according to some embodiments of the present disclosure;

FIG. 3D shows a schematic diagram illustrating processing of input/output (I/O) data in a VDM according to some embodiments of the present disclosure;

FIG. 4 shows a flow chart of a method of balancing loads between different SPs according to some embodiments of the present disclosure;

FIG. 5 shows a schematic diagram of a process of balancing loads between different SPs according to some embodiments of the present disclosure;

FIG. 6 shows a schematic diagram of the effect after offloading a compression load according to some embodiments of the present disclosure; and

FIG. 7 shows a block diagram of a device that can implement multiple embodiments of the present disclosure.

### DETAILED DESCRIPTION

Illustrative embodiments of the present disclosure will be described in more detail below with reference to the accompanying drawings. Although some embodiments of the present disclosure are illustrated in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and embodiments of the present disclosure are for illustrative purposes only, and are not intended to limit the scope of protection of the present disclosure.

In the description of embodiments of the present disclosure, the term “include” and similar terms thereof should be understood as open-ended inclusion, i.e., “including but not limited to.” The term “based on” should be understood as “based at least in part on.” The term “an embodiment” or “the embodiment” should be construed as “at least one embodiment.” The terms “first,” “second,” and the like may refer to different or the same objects. Other explicit and implicit definitions may also be included below.

In a storage system, an SP is usually arranged for managing, monitoring, and maintaining the stable operation of the entire storage environment. The SP has built-in independent CPU and memory resources, enabling it to perform a variety of tasks independently of a main storage system processor. For example, a VDM is utilized to coordinate and manage the flow of data stored in the system to ensure efficient access and security of the data. Generally, an SP may include a plurality of VDMs, and each VDM may independently perform data compression and decompression tasks related to user I/O operations, so as to reduce the bandwidth and storage space required for data transmission.

As mentioned above, the VDM can use the SMB protocol to compress, in real time, data to be written to a storage medium, and automatically decompress it when reading, thereby ensuring that the integrity and availability of the data are not affected. However, some specific VDMs undertake a large number of compression tasks, which may occupy too many CPU resources, thus causing competition for resources. VDMs with a large number of tasks may obtain resources first, while VDMs with a small number of tasks may be delayed due to insufficient resources, which results in a decrease in the system response speed, a reduced throughput, and poor user experience.

To address these and other problems, embodiments of the present disclosure provide a solution for offloading a compression load. A method in an illustrative embodiment includes determining a compression ratio of an SP in a storage system according to raw data and compressed data, determining a target VDM associated with a compression task from a plurality of VDMs in the SP when the compression ratio of the SP is greater than a predetermined threshold, and then offloading the target VDM to a DPU connected to the SP. In this way, the DPU can be used to expand the resources of the SP, process compression tasks, reduce the load on a CPU in the SP, and reduce competition for resources, thereby improving the compression efficiency and system performance, and optimizing the user experience.

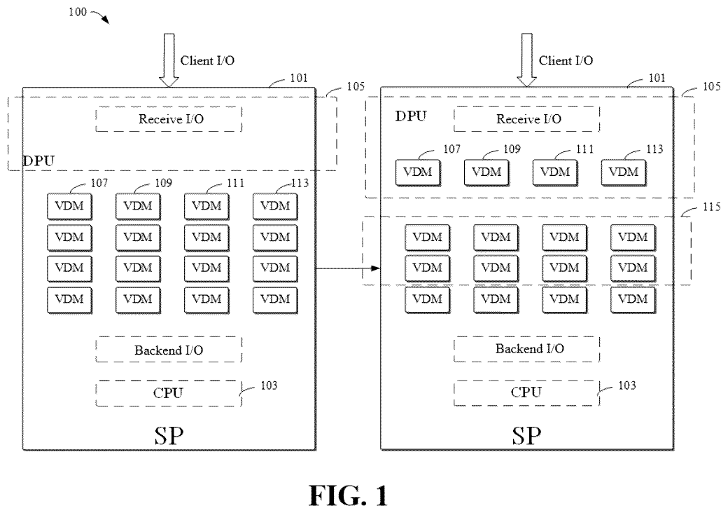

FIG. 1 shows a schematic diagram of an example environment 100 in which multiple embodiments of the present disclosure can be implemented. As shown in FIG. 1, the example environment 100 may include an SP 101. The SP 101 is a component in a storage system used for managing, monitoring, and maintaining stable operation of the entire storage environment. By arranging an independent CPU 103 and memory resources, the SP 101 has independent computing power and resource management permissions, and can coordinate storage resources, optimize data flows, and ensure data security. Generally, the storage system can receive and process a client I/O and a backend I/O through the SP 101. The client I/O refers to a direct data read and write request from a user or an application, and the backend I/O refers to a data processing task automatically performed within the storage system, such as data migration, garbage collection, and index update. The SP 101 can use a VDM to process the client I/O and the backend I/O.

In embodiments of the present disclosure, the SP 101 may include a plurality of VDMs. The VDMs are independent units within the SP 101 used for processing data operations. Each VDM can simulate functions of one or a plurality of CPU cores to perform specific data processing tasks, such as data compression, decompression, encryption, and decryption. According to business needs, each VDM can independently perform data compression and decompression tasks related to user I/O operations. Different VDMs can be configured according to the needs of different departments (such as a finance department and an administrative department) to adapt to different data compression levels and security requirements. For example, data that needs to be highly confidential may be processed by a specific VDM that performs higher levels of compression and encryption, and therefore, different VDMs have different numbers of compression tasks.

In embodiments of the present disclosure, the SP 101 is connected to a DPU 105. The DPU 105 can process large-scale data workloads within a data center, including data transmission, protocol, protection, compression, analysis, encryption, and the like. As shown in FIG. 1, the DPU 105 can transmit data between a server and a client, and share network and communication workloads for a CPU in the SP 101, for example, receiving and processing a client I/O. The client I/O data usually includes raw data and compressed data. A compression ratio of the SP 101 can be determined based on a ratio sum of the raw data to the compressed data. It should be understood that, based on the amount of the raw data and the amount of the compressed data, it can be determined whether the SP 101 has intensive compression tasks. When the SP 101 has intensive compression tasks, it usually means that there is an unbalanced resource allocation problem within the storage system. In particular, when several modules in a plurality of VDMs undertake extremely heavy compressed data processing tasks, this high-load state not only intensifies the competition for CPU resources, but may also lead to increased system response delays and a significant decline in overall performance, which in turn affects the efficiency and stability of business processing.

In some embodiments, in order to solve the above overload problem, a compression task-intensive VDM among a plurality of VDMs may be determined as a target VDM. The method for determining the target VDM may be real-time monitoring performance indicators of various VDMs in the system, such as the CPU usage rate, memory occupancy, and disk I/O rate, to identify which VDMs are performing a large number of compression tasks, or may be evaluating the resource usage rate of each VDM, especially resources directly related to compression tasks, to determine the compression task-intensive VDM. The method for determining the target VDM may be selected according to actual needs, which is not limited in the present disclosure.

As shown in FIG. 1, after the target VDM is determined, these compression task-intensive VDMs can be offloaded from the load of the CPU and handed over to the DPU 105 for execution. As a component designed specifically to accelerate data processing, the DPU 105 can efficiently handle a variety of computation-intensive tasks including data compression, thereby significantly reducing the burden on the CPU and improving the overall parallel processing capability and response speed of the system. For example, VDMs with a large number of compression tasks such as a VDM 107, a VDM 109, a VDM 111, and a VDM 113 may be offloaded to the DPU 105, so that the remaining VDM set 115 including a small number of compression tasks can fully utilize the released CPU resources.

According to embodiments of the present disclosure, the compression ratio of the SP in the storage system is determined according to the raw data and the compressed data, and when the compression ratio of the SP is greater than the predetermined threshold, the target VDM associated with the compression task is determined from the plurality of VDMs in the SP, and then the target VDM is offloaded to the DPU connected to the SP. In this way, the DPU can be utilized to expand the amount of resources of the SP and process the compression tasks, and the powerful computing power of the DPU can be utilized to improve the speed of completing the compression tasks and improve the compression efficiency, which helps the storage system complete the data write and read operations faster, thereby reducing the load on the CPU in the SP, reducing the competition for resources, improving the performance of the storage system, and optimizing the user experience.

It should be understood that the architecture and functions in the example environment 100 are described only for illustrative purposes, without implying any limitation to the scope of the present disclosure. Embodiments of the present disclosure can also be applied to other environments with different structures and/or functions.

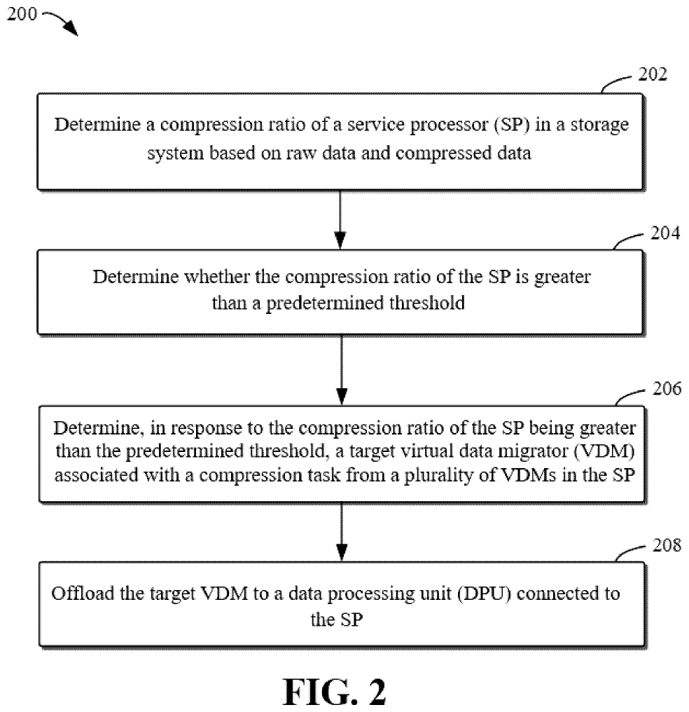

The process in embodiments of the present disclosure will be described in detail below with reference to FIG. 2 to FIG. 6. For ease of understanding, specific data mentioned in the following description is illustrative and is not intended to limit the protection scope of the present disclosure. It should be understood that the embodiments described below may also include additional actions not shown and/or may omit actions shown, and the scope of the present disclosure is not limited in this regard.

FIG. 2 shows a flow chart of a method 200 for offloading a compression load according to some embodiments of the present disclosure. At a block 202, a compression ratio of an SP in a storage system is determined based on raw data and compressed data. For example, as shown in FIG. 1, the SP 101 may receive client I/O data through the DPU 105. The client I/O data usually includes raw data and compressed data. The compression ratio of the SP 101 can be determined based on a ratio sum of the raw data to the compressed data. It should be understood that, based on the amount of the raw data and the amount of the compressed data, it can be determined whether the SP 101 has intensive compression tasks.

At a block 204, it is determined whether the compression ratio of the SP is greater than a predetermined threshold. For example, as shown in FIG. 1, a predetermined threshold may be configured for the SP 101. When the compression ratio of the SP 101 is greater than the predetermined threshold, it is determined that there are excessive compression tasks in the SP 101. When the compression ratio of the SP 101 is less than or equal to the predetermined threshold, it is determined that resources in the SP 101 are sufficient to support execution of the compression load.

At a block 206, in response to the compression ratio of the SP being greater than the predetermined threshold, a target VDM associated with a compression task is determined from a plurality of VDMs in the SP. For example, as shown in FIG. 1, when the SP 101 has excessive compression tasks, a compression task-intensive VDM among the plurality of VDMs may be determined as a target VDM. The method for determining the target VDM may be real-time monitoring performance indicators of various VDMs in the system, such as the CPU usage rate, memory occupancy, and disk I/O rate, to identify which VDMs are performing a large number of compression tasks, or may be evaluating the resource usage rate of each VDM, especially resources directly related to compression tasks, to determine the compression task-intensive VDM. The method for determining the target VDM may be selected according to actual needs, which is not limited in the present disclosure.

At a block 208, the target VDM is offloaded to a DPU connected to the SP. For example, as shown in FIG. 1, the target VDM can be offloaded to the DPU connected to the SP by a management entity of the storage system, where the management entity illustratively comprises at least one control process (CP) or other management-related component in the storage system. The CP is used for performing management, monitoring, scheduling, and decision-making functions in the storage system. When the storage system includes a plurality of SPs, the CP can run on any SP in a high-availability manner. For example, when the target VDM includes the VDM 107, the VDM 109, the VDM 111, and the VDM 113, the CP may offload the VDMs with a large number of compression tasks to the DPU 105.

In this way, the DPU can be utilized to expand the amount of resources of the SP and process the compression tasks, and the powerful computing power of the DPU can be utilized to improve the speed of completing the compression tasks and improve the compression efficiency, which helps the storage system complete the data write and read operations faster, thereby reducing the load on the CPU in the SP, reducing the competition for resources, improving the performance of the storage system, and optimizing the user experience.

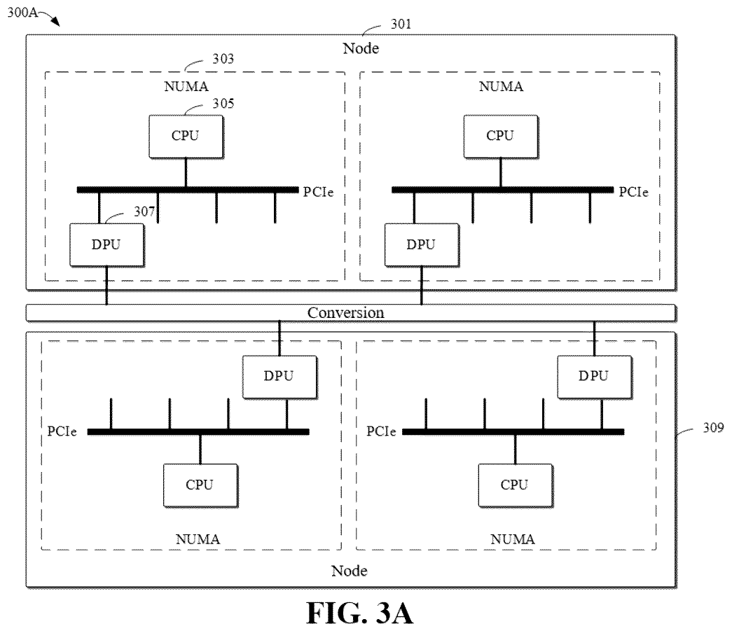

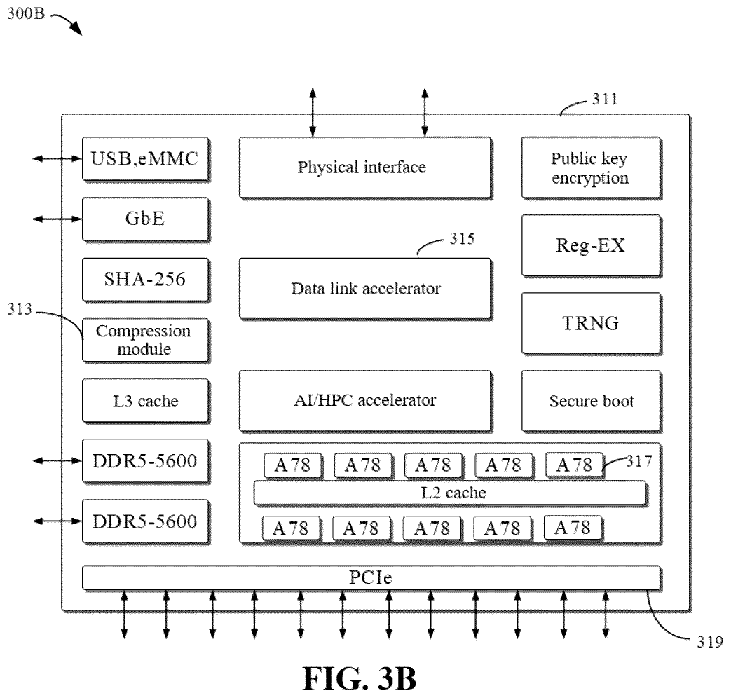

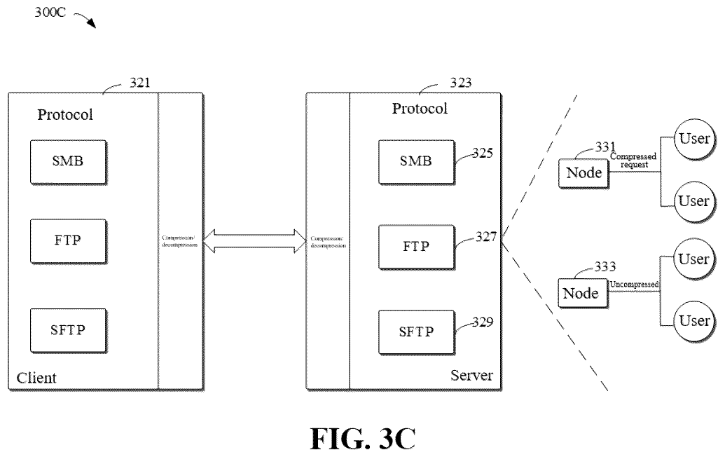

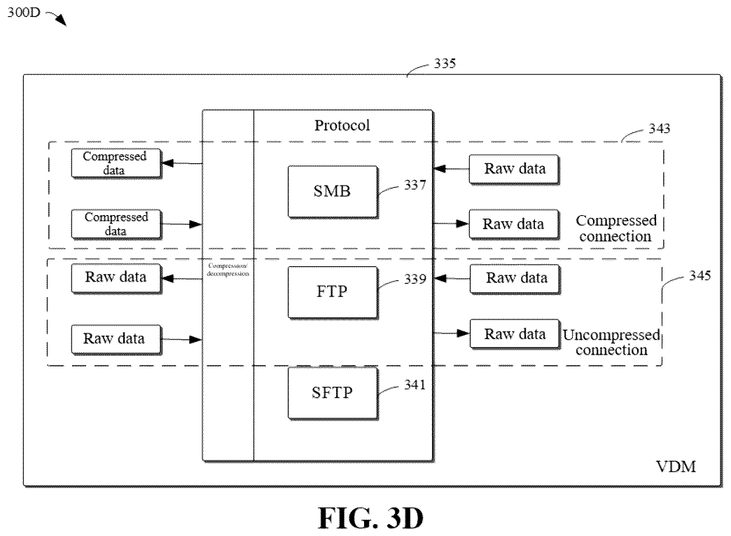

An example process of scheduling resources will be specifically described below with reference to FIG. 3A to FIG. 7. In embodiments of the present disclosure, explanations are given in the order of connection between the DPU and the CPU, architecture of the DPU, compression/decompression process of the client and the server, load balancing between different SPs, and effect after load balancing. The specific data mentioned in the following description are all illustrative and are not intended to limit the scope of protection of the present disclosure. It should be understood that the embodiments described below may also include additional actions not shown and/or may omit actions shown, and the scope of the present disclosure is not limited in this regard.

FIG. 3A shows a schematic diagram of a connection 300A between a CPU and a DPU according to some embodiments of the present disclosure. As shown in FIG. 3A, the storage system may include a plurality of nodes. A node 301 and a node 309 correspond to two different SPs. The node 301 includes a non-uniform memory access (NUMA) region 303. The NUMA region 303 allows the storage system to have a large amount of memory while maintaining a high memory access speed. Each node may include one or a plurality of NUMA regions. In FIG. 3A, each NUMA region 303 represents such a memory access region including a CPU 305 and a DPU 307, which share the memory of the NUMA region 303. In embodiments of the present disclosure, the CPU 305 may be connected to the DPU 307 via a peripheral component interconnect express (PCIe), and through the PCIe, the CP in the storage system can offload the VDM in the CPU 305 to the DPU 307.

In some embodiments, DPUs between different nodes may be connected to each other. For example, a plurality of DPUs between the node 301 and the node 309 may be connected to each other. In this way, the VDM of the CPU 305 can be offloaded not only to the DPU 307, but also to another DPU of the same node 301, or to a DPU of the node 309. The CP of the storage system may flexibly offload VDM tasks to different DPUs according to the current system load and DPU availability, so as to more efficiently utilize computing resources of the system.

FIG. 3B shows a schematic diagram of architecture 300B of a DPU according to some embodiments of the present disclosure. As shown in FIG. 3B, a DPU 311 may include a compression module 313, a data link accelerator 315, a plurality of cores 317 (e.g., a plurality of A78 cores as shown, each a separate ARM processing core), and a PCIe 319. The compression module 313 may be used for performing a compression task that is offloaded to the DPU 311, thereby significantly reducing the workload of a main processor and improving the overall system efficiency. The data link accelerator 315 ensures, by optimizing the data transmission path and reducing processing delays, that data can flow and be processed at a very high speed inside the DPU 311, thereby accelerating the execution rate of compression tasks. A given one of the cores 317 is equivalent to a computing unit inside the DPU and is used for performing various computing tasks, such as data processing, encryption and decryption, compression and decompression, and network data processing. The PCIe 319 is used for realizing communication between the DPU 311 and the SP. The PCIe 319 not only supports high-speed data transmission, but also enables the DPU 311 to flexibly offload a compression task from the CPU to itself for execution, thereby further improving the overall performance and response speed of the system. The DPU 311 may also include other components, such as a public key encryption module, a secure boot module, a physical interface, an L2 cache, an L3 cache, a true random number generator (TRNG), an artificial intelligence and/or high-performance computing (AI/HPC) accelerator, a regular expression (Reg-EX) processor, a hash function module (e.g., SHA-256), a Gigabit Ethernet (GbE) interface, universal serial bus (USB) and embedded multimedia card (eMMC) interfaces, and double data rate (DDR) memory interfaces, as illustrated in the figure. Principles and functions of these other components are consistent with DPU components in the related art and will not be further described herein.

FIG. 3C shows a schematic diagram of a process 300C of performing data transmission between a client and a server according to some embodiments of the present disclosure. As shown in FIG. 3C, data may be transmitted between a client 321 and a server 323 through a variety of protocols, such as an SMB protocol 325, an FTP protocol 327, and an SFTP protocol 329, and these protocols determine rules for how data is formatted, transmitted, and received. As described above, the SMB protocol 325 can provide data compression/decompression functions between the client 321 and the server 323. The FTP protocol 327 belongs to the application layer protocol and uses the Transmission Control Protocol as the transport layer protocol. The FTP protocol 327 can support uploading and downloading of files. Compared with the FTP protocol 327, the SFTP protocol 329 provides higher security because it encrypts data during transmission, thus preventing the data from being eavesdropped on or tampered with.

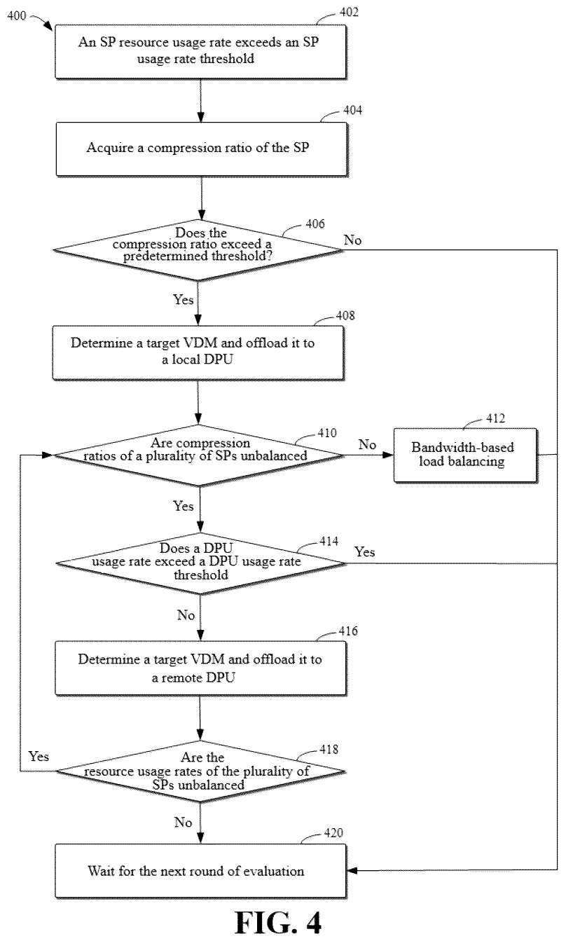

In some instances, part of the data in the client 321 and the server 323 may be transmitted using the SMB protocol 325, and the other part of the data may be transmitted using the FTP protocol 327 or the SFTP protocol 329. The data transmitted using the SMB protocol 325 usually requires compression/decompression. In a multi-node storage system, the numbers of compression tasks of different nodes are usually different. For example, all clients connected to a node 331 use a compression request, and all clients connected to a node 333 use a non-compression request. As a result, the network bandwidth of the node 333 may be fully occupied, and the disk load and CPU load are relatively low because uncompressed data does not consume too many computing and I/O resources. However, on the node 331, the network bandwidth usage rate will be very low, and the disk load and CPU load will be very high, because compression reduces the size of data transmission, increases the disk I/O throughput, and meanwhile consumes more CPU resources. Therefore, in order to balance the compression load among a plurality of nodes, the compression task on one node may be offloaded to another node. The specific content of the load balancing method may be obtained with reference to FIG. 4.

FIG. 3D shows a schematic diagram illustrating processing of I/O data 300D in a VDM according to some embodiments of the present disclosure. As shown in FIG. 3D, when an SP includes a plurality of VDMs, due to the independence between the VDMs, each VDM may include an SMB protocol layer to implement data compression and transmission. For example, a VDM 335 includes an SMB protocol 337, an FTP protocol 339, and an SFTP protocol 341. The SMB protocol 337, the FTP protocol 339, and the SFTP protocol 341 are consistent with the SMB protocol 325, the FTP protocol 327, and the SFTP protocol 329 in FIG. 3C, and description thereof is not repeated herein. The VDM 335 transmits, via the SMB protocol 337, compressed data 343 that may need to be compressed/decompressed, while data transmitted via the FTP protocol 339 is raw data 345 that is not processed.

FIG. 4 shows a flow chart of a process 400 for determining a designated core of a target container according to some embodiments of the present disclosure. At a block 402, it is determined that an SP resource usage rate exceeds an SP usage rate threshold. In some embodiments, monitoring tools provided by the storage system itself or provided by a third party may be used to obtain a resource usage rate of each SP in the storage system. These tools may display in real time the usage of key resources, such as the CPU usage rate, memory occupancy, disk I/O, and network bandwidth. Based on the usage rates of key resources such as the CPU usage rate, memory occupancy, disk I/O, and network bandwidth, it may be determined that the SP resource usage rate exceeds the SP usage rate threshold. The SP usage rate threshold may be a value set in advance according to actual needs. When the SP resource usage rate exceeds the SP usage rate threshold, the compression load in the SP may be too heavy.

At a block 404, a compression ratio of the SP is acquired. For example, as shown in FIG. 3D, I/O data of each compression session in each VDM 335 may be periodically acquired. The acquired I/O data may include compressed data and raw data, or may only include raw data. The I/O data may be represented by the following formula:

$$Total\_Raw \_Data = Uncompressed\_Data + Raw\_Data \_in \_Compression \qquad ( 1 )$$

wherein Total_Raw_Data represents I/O data, Uncompressed_Data represents raw data, and Raw_Data_in_Compression represents compressed data. After the I/O data of the compression session is determined, the compression ratio of each compression session may be determined:

$$Compression\_Data \_Percentage = \frac{Raw\_Data \_in \_Compression}{Total\_Raw \_Data} \qquad ( 2 )$$

When there are n compression sessions in a VDM, after determining the compression ratio of each compression session, the compression ratio of each VDM may be determined according to the compression ratios of the n compression sessions:

$$VDM\_Compression \_Percentage = \frac{{\sum }_{i = 0}^{n} Raw\_Data \_in {\_Compression}_{i}}{{\sum }_{i = 0}^{n} Total\_Raw {\_Data}_{i}} \qquad ( 3 )$$

When there are m VDMs in an SP, after determining the compression ratio of each VDM, the compression ratio of each SP may be determined according to the compression ratios of the m VDMs:

$$SP\_Compression \_Percentage = \frac{{\sum }_{i = 0}^{m} VDM\_Raw \_Data \_in {\_Compression}_{i}}{{\sum }_{i = 0}^{m} VDM\_Total \_Raw {\_Data}_{i}} \qquad ( 4 )$$

At a block 406, it is determined whether the compression ratio exceeds a predetermined threshold. When the compression ratio of the SP exceeds the predetermined threshold, it usually means that several modules in a plurality of VDMs undertake extremely heavy compressed data processing tasks, and this high-load state not only intensifies the competition for resources of the CPU, but may also lead to increased system response delays and a significant decline in overall performance, which in turn affects the efficiency and stability of business processing. At this point, a block 408 is performed to determine a target VDM and offload it into a local DPU. In embodiments of the present disclosure, the compression ratio of each VDM may be obtained according to the formula (3), a plurality of VDMs are sorted according to the compression ratios, and the VDM with a high compression ratio is determined as the target VDM and offloaded to a local DPU. The process of offloading to a local DPU may be obtained with reference to FIG. 1. When the compression ratio of the SP does not exceed the predetermined threshold, a block 420 is performed to wait for the next round of evaluation, in other words, wait for the next round of calculation and evaluation of the compression ratio of the SP.

At a block 410, it is determined whether the compression ratios of a plurality of SPs are unbalanced. In some embodiments, whether the compression ratios of a plurality of SPs are unbalanced may be determined based on a difference between the compression ratios of every two SPs. First, the compression ratio of each SP may be obtained according to the formula (4), and a difference between the compression ratios of every two SPs in the plurality of SPs is calculated. When the difference is greater than a given value, it may be determined that one SP of the two SPs performs more compression tasks and occupies more resources, and the resource allocation between the two SPs is unbalanced. At this time, a block 414 is performed to determine whether a DPU usage rate exceeds a DPU usage rate threshold. The DPU usage rate may also be determined using a monitoring tool provided by the system itself. When the DPU usage rate does not exceed the usage rate threshold, it means that there is still room for use of the DPU, and a block 416 is performed; otherwise, wait for the next round of evaluation.

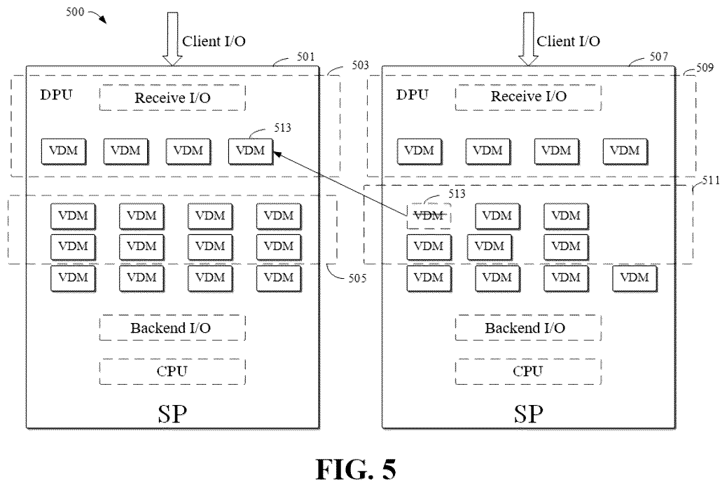

At a block 416, a target VDM is determined and offloaded to a remote DPU. The process of offloading to a remote DPU may be obtained with reference to FIG. 5. In contrast, when the compression ratios of a plurality of SPs are balanced, it means that there is not much difference in the numbers of compression tasks of the plurality of SPs, and then a block 412 may be performed to control the load balancing between the plurality of SPs based on bandwidth. The method of bandwidth-based load balancing is consistent with the relevant technology and will not be further described herein. At a block 418, it is determined whether the resource usage rates of the plurality of SPs are unbalanced. Whether the resource usage rates of the SPs are balanced may also be determined according to whether a difference between every two SPs in the plurality of SPs is greater than a preset difference. Of course, it may also be determined according to other methods, which are not limited in the present disclosure. When the resource usage rates of the plurality of SPs are balanced, it is feasible to wait for the next round of evaluation. When the resource usage rates of the plurality of SPs are unbalanced, the process returns to the block 410 and performs the next round of load balancing until the resource usage rates of the plurality of SPs are balanced. During the second round of load balancing, the VDMs that have been offloaded in the first round will not be moved again, so as to ensure the stability of the system operation.

In this way, when the compression ratio of a certain SP is too high, by offloading some high-load VDMs to a remote DPU, the resources on the original SP may be released so that these resources may be used by other tasks or VDMs. The system may flexibly adjust resource allocation according to actual needs, thereby improving the resource utilization of the entire system. When business needs increase, the system capacity may be expanded by adding DPUs or optimizing load balancing strategies to meet the changing demands. A high-load SP may cause increased system response delays because the CPU needs to handle a large number of compression tasks and cannot respond to other requests in a timely manner. By load balancing, the load on each SP may be reduced, system response delays may be reduced, and the overall system performance and user experience may be improved. In addition, the load balancing may also reduce the task processing bottleneck caused by overloading of a single SP, allowing task requests to be processed more quickly.

FIG. 5 shows a schematic diagram of a process 500 of balancing loads between different SPs according to some embodiments of the present disclosure. As shown in FIG. 5, when a difference between compression ratios of an SP 501 and an SP 507 is greater than a given value, it may be determined that compression loads of the SP 501 and the SP 507 are unbalanced. In embodiments of the present disclosure, the compression ratio of the SP 507 is greater than the compression ratio of the SP 501, then it is necessary to determine a VDM with a high compression ratio in the SP 507 as a target VDM and offload it to a DPU 503 connected to the SP 501, that is, to offload the target VDM in the SP with a high compression ratio to a DPU of a remote SP. For example, in an SP 507, a VDM 513 has the highest compression ratio, and therefore, the VDM 513 may be determined as the target VDM, and the VDM 513 is offloaded by a CP to the DPU 503 through a PCIe. By adopting the above offloading method, the compression loads between the SP 501 and the SP 507 may be balanced, so that the compression loads of the DPU 503 and the DPU 509 can also be balanced and controlled, and the remaining VDM set 505 and VDM set 511 including a small number of compression tasks can make full use of the released resources.

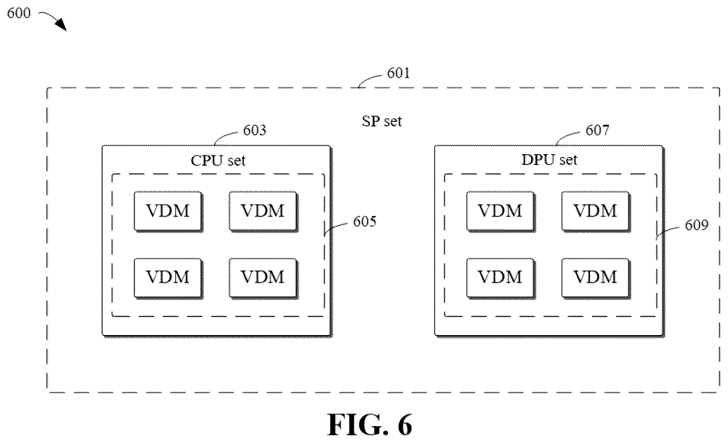

FIG. 6 shows a schematic diagram of effect 600 after offloading a compression load according to some embodiments of the present disclosure. As shown in FIG. 6, in an SP set 601, a VDM set 605 that does not perform compression tasks runs on a CPU set 603, and a compression task-intensive VDM set 609 runs on a DPU set 607. In the present disclosure, by introducing a DPU in a storage system, the protocol layer compression is selected to be offloaded to the DPU, thereby achieving better performance. The protocol layer compression is dynamically deployed across different computing resources in a multi-node storage system, thereby avoiding node hotspots caused by resource limitations. By balancing I/O and workloads between CPU and DPU resources, the overall performance of the storage system can be improved.

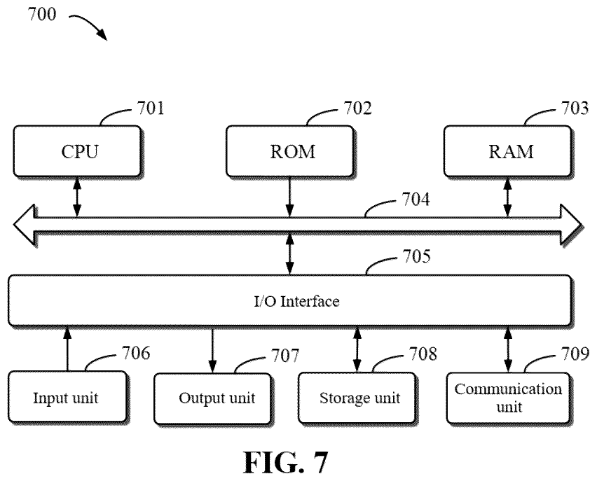

FIG. 7 shows a block diagram of an example device 700 which can be used to implement embodiments of the present disclosure. As shown in the figure, the device 700 includes a computing unit 701, illustratively comprising at least one CPU, that can perform various appropriate actions and processing according to computer program instructions stored in a read-only memory (ROM) 702 or computer program instructions loaded from a storage unit 708 to a random access memory (RAM) 703. Various programs and data required for the operation of the device 700 may also be stored in the RAM 703. The computing unit 701, the ROM 702, and the RAM 703 are connected to each other via a bus 704. An I/O interface 705 is also connected to the bus 704.

Multiple components in the device 700 are connected to the I/O interface 705, including: an input unit 706, such as a keyboard and a mouse; an output unit 707, such as various types of displays and speakers; the storage unit 708, such as a magnetic disk and an optical disc; and a communication unit 709, such as a network card, a modem, and a wireless communication transceiver. The communication unit 709 allows the device 700 to exchange information/data with other devices via a computer network, such as the Internet, and/or various telecommunication networks.

The computing unit 701 may be various general-purpose and/or special-purpose processing components with processing and computing powers. Some examples of the computing unit 701 include, but are not limited to, the above-noted one or more CPUs, graphics processing units (GPUs), various specialized artificial intelligence (AI) computing chips, various computing units for running machine learning model algorithms, digital signal processors (DSPs), and any appropriate processors, controllers, microcontrollers, etc. The computing unit 701 performs various methods and processing described above, such as the method 200. For example, in some embodiments, the method 200 may be implemented as a computer software program that is tangibly included in a machine readable medium, such as the storage unit 708. In some embodiments, part or all of the computer program may be loaded and/or installed onto the device 700 via the ROM 702 and/or the communication unit 709. When the computer program is loaded to the RAM 703 and executed by the computing unit 701, one or more steps of the method 200 described above may be performed. Alternatively, in other embodiments, the computing unit 701 may be configured to implement the method 200 in any other suitable manners (such as by means of firmware).

The functions described herein may be executed at least in part by one or more hardware logic components. For example, non-restrictively, illustrative types of hardware logic components that can be used include Field Programmable Gate Arrays (FPGAs), Application Specific Integrated Circuits (ASICs), Application Specific Standard Parts (ASSPs), Systems On Chip (SOC), Complex Programmable Logic Devices (CPLDs), etc.

Program code for implementing the method of the present disclosure may be written by using one programming language or any combination of multiple programming languages. The program code may be provided to a processor or controller of a general purpose computer, a special purpose computer, or another programmable data processing apparatus, such that the program code, when executed by the processor or controller, implements the functions/operations specified in the flow charts and/or block diagrams. The program code may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include one or more wire-based electrical connections, a portable computer diskette, a hard disk, a RAM, a ROM, an erasable programmable read-only memory (EPROM or flash memory), an optical fiber, a portable compact disc read-only memory (CD-ROM), an optical storage device, a magnetic storage device, or any suitable combination thereof. Additionally, although operations are depicted in a particular order, this should not be construed as an indication that such operations are required to be performed in the particular order shown or in a sequential order, or that all illustrated operations should be performed to achieve desirable results. Under certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. Conversely, various features that are described in the context of a single implementation may also be implemented in a plurality of implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the particular features and actions described above are merely example forms of implementing the claims.

What is claimed is:

1. A method for offloading a compression load, comprising:
determining a compression ratio of a service processor (SP) in a storage system based on raw data and compressed data;
determining whether the compression ratio of the SP is greater than a predetermined threshold;
determining, in response to the compression ratio of the SP being greater than the predetermined threshold, a target virtual data migrator (VDM) associated with a compression task from a plurality of VDMs in the SP; and
offloading the target VDM to a data processing unit (DPU) connected to the SP.

2. The method according to claim 1, wherein determining the compression ratio of the SP in the storage system comprises:
determining whether a resource usage rate of the SP is greater than an SP usage rate threshold; and
determining, in response to the resource usage rate of the SP being greater than the SP usage rate threshold, the compression ratio of the SP in the storage system.

3. The method according to claim 2, wherein determining the compression ratio of the SP in the storage system further comprises:
determining a plurality of compression ratios of a plurality of compression sessions in each VDM based on a ratio of the raw data to the compressed data;
determining a compression ratio of each VDM in the plurality of VDMs based on the plurality of compression ratios of the plurality of compression sessions; and
determining the compression ratio of the SP based on the compression ratio of each VDM in the SP.

4. The method according to claim 3, wherein determining the target VDM associated with the compression task from the plurality of VDMs in the SP comprises:
sorting the plurality of VDMs based on the compression ratio of each VDM in the SP; and
determining, based on the result of sorting the plurality of VDMs, the target VDM from the plurality of VDMs in the SP.

5. The method according to claim 1, wherein the SP comprises a first SP and a second SP, a compression ratio of the first SP is greater than a compression ratio of the second SP, and determining the target VDM associated with the compression task from the plurality of VDMs in the SP comprises:
determining, in response to the compression ratio of the first SP being greater than the predetermined threshold, whether a difference between the compression ratio of the first SP and the compression ratio of the second SP is greater than a given value; and
determining, in response to the difference between the compression ratio of the first SP and the compression ratio of the second SP being greater than the given value, the target VDM associated with the compression task from a plurality of VDMs of the first SP.

6. The method according to claim 5, wherein offloading the target VDM to the DPU connected to the SP comprises:
determining whether a usage rate of a DPU connected to the second SP is less than a DPU usage rate threshold; and
offloading, in response to the usage rate being less than the DPU usage rate threshold, the target VDM to the DPU connected to the second SP.

7. The method according to claim 5, wherein the method further comprises:
controlling, in response to the difference between the compression ratio of the first SP and the compression ratio of the second SP being less than or equal to the given value, load balancing between the first SP and the second SP based on bandwidth utilizations of the first SP and the second SP.

8. The method according to claim 1, wherein offloading the target VDM to the DPU connected to the SP comprises:
determining whether a usage rate of a DPU connected to an SP comprising the target VDM is less than a DPU usage rate threshold; and
offloading, in response to the usage rate being less than the DPU usage rate threshold, the target VDM to the DPU through a management entity in the storage system.

9. The method according to claim 1, wherein the method further comprises:
performing the compression task associated with the target VDM by the DPU.

10. An electronic device, comprising:
at least one processor; and
memory coupled to the at least one processor and having instructions stored therein, wherein the instructions, when executed by the at least one processor, cause the electronic device to perform actions comprising:
determining a compression ratio of a service processor (SP) in a storage system based on raw data and compressed data;
determining whether the compression ratio of the SP is greater than a predetermined threshold;
determining, in response to the compression ratio of the SP being greater than the predetermined threshold, a target virtual data migrator (VDM) associated with a compression task from a plurality of VDMs in the SP; and
offloading the target VDM to a data processing unit (DPU) connected to the SP.

11. The electronic device according to claim 10, wherein determining the compression ratio of the SP in the storage system comprises:
determining whether a resource usage rate of the SP is greater than an SP usage rate threshold; and
determining, in response to the resource usage rate of the SP being greater than the SP usage rate threshold, the compression ratio of the SP in the storage system.

12. The electronic device according to claim 11, wherein determining the compression ratio of the SP in the storage system further comprises:
determining a plurality of compression ratios of a plurality of compression sessions in each VDM based on a ratio of the raw data to the compressed data;
determining a compression ratio of each VDM in the plurality of VDMs based on the plurality of compression ratios of the plurality of compression sessions; and
determining the compression ratio of the SP based on the compression ratio of each VDM in the SP.

13. The electronic device according to claim 12, wherein determining the target VDM associated with the compression task from the plurality of VDMs in the SP further comprises:
sorting the plurality of VDMs based on the compression ratio of each VDM in the SP; and
determining, based on the result of sorting the plurality of VDMs, the target VDM from the plurality of VDMs in the SP.

14. The electronic device according to claim 10, wherein the SP comprises a first SP and a second SP, a compression ratio of the first SP is greater than a compression ratio of the second SP, and determining the target VDM associated with the compression task from the plurality of VDMs in the SP further comprises:
determining, in response to the compression ratio of the first SP being greater than the predetermined threshold, whether a difference between the compression ratio of the first SP and the compression ratio of the second SP is greater than a given value; and
determining, in response to the difference between the compression ratio of the first SP and the compression ratio of the second SP being greater than the given value, the target VDM associated with the compression task from a plurality of VDMs of the first SP.

15. The electronic device according to claim 14, wherein offloading the target VDM to the DPU connected to the SP further comprises:
determining whether a usage rate of a DPU connected to the second SP is less than a DPU usage rate threshold; and
offloading, in response to the usage rate being less than the DPU usage rate threshold, the target VDM to the DPU connected to the second SP.

16. The electronic device according to claim 14, wherein the actions further comprise:
controlling, in response to the difference between the compression ratio of the first SP and the compression ratio of the second SP being less than or equal to the given value, load balancing between the first SP and the second SP based on bandwidth utilizations of the first SP and the second SP.

17. The electronic device according to claim 10, wherein offloading the target VDM to the DPU connected to the SP further comprises:
determining whether a usage rate of a DPU connected to an SP comprising the target VDM is less than a DPU usage rate threshold; and
offloading, in response to the usage rate being less than the DPU usage rate threshold, the target VDM to the DPU through a management entity in the storage system.

18. The electronic device according to claim 10, wherein the actions further comprise:
performing the compression task associated with the target VDM by the DPU.

19. A computer program product tangibly stored on a non-transitory computer-readable medium and comprising machine-executable instructions which, when executed by a machine, cause the machine to perform actions comprising:
determining a compression ratio of a service processor (SP) in a storage system based on raw data and compressed data;
determining whether the compression ratio of the SP is greater than a predetermined threshold;
determining, in response to the compression ratio of the SP being greater than the predetermined threshold, a target virtual data migrator (VDM) associated with a compression task from a plurality of VDMs in the SP; and
offloading the target VDM to a data processing unit (DPU) connected to the SP.

20. The computer program product according to claim 19, wherein determining the compression ratio of the SP in the storage system comprises:
determining whether a resource usage rate of the SP is greater than an SP usage rate threshold; and
determining, in response to the resource usage rate of the SP being greater than the SP usage rate threshold, the compression ratio of the SP in the storage system.
